(19) United States
(12) Patent Application Publication
(10) Pub. No.: US 2026/0231940 A1
(43) Pub. Date: Aug. 13, 2026

(54) METHOD FOR ATTRACTING COCKROACHES, COCKROACH ATTRACTANT, AND METHOD FOR CONTROLLING COCKROACHES

(71) Applicant: SUMITOMO CHEMICAL COMPANY, LIMITED, Tokyo (JP)

(72) Inventor: Michiko NAKAMURA, Takarazuka-shi, Hyogo (JP)

(73) Assignee: SUMITOMO CHEMICAL COMPANY, LIMITED, Tokyo (JP)

(21) Appl. No.: 19/154,707

(22) PCT Filed: Feb. 26, 2024
(86) PCT No.: PCT/JP2024/006737

§ 371 Date: Aug. 7, 2025

(30) Foreign Application Priority Data
Mar. 1, 2023 (JP) 2023-030785

(51) Int. Cl. A01N 43/40; A01N 31/02; A01N 47/34; A01P 19/00

(52) U.S. Cl. CPC A01N 43/40; A01N 31/02; A01N 47/34; A01P 19/00

(57) ABSTRACT

The method for attracting cockroaches attracts cockroaches using one or more insect growth-regulating compounds. The cockroach attractant contains one or more insect growth-regulating compounds for attracting cockroaches. The method for controlling cockroaches contains attracting cockroaches using one or more insect growth-regulating compounds.

### TECHNICAL FIELD

This patent application claims priority to and the benefit of Japanese Patent Application No. 2023-030785 filed on Mar. 1, 2023 under the Paris Convention, the entire contents of which are incorporated by reference into this description.

The present invention relates to a method for attracting cockroaches, a cockroach attractant, and a method for controlling cockroaches.

### BACKGROUND ART

It is known to use insect pest attractants in combination with insecticides in order to enhance the control effect against insect pests such as cockroaches (Patent Literature 1).

Insect growth regulators are sometimes used for controlling insect pests. Patent Literature 2 describes the installation of insect growth regulators in containers for capturing cockroaches.

### CITATION LIST

### Patent Literatures

Patent Literature 1: Japanese Unexamined Patent Publication No. 2015-51965
Patent Literature 2: Japanese Unexamined Patent Publication No. 2002-155

### SUMMARY OF THE INVENTION

### Problem to be Solved by the Invention

The present invention aims to provide a novel method for attracting cockroaches, cockroach attractant, and a method for controlling cockroaches.

### Means for Solving the Problem

The present invention provides the following methods for attracting cockroaches, cockroach attractants, and methods for controlling cockroaches.

[1] A method for attracting cockroaches, attracting cockroaches using one or more insect growth-regulating compounds.

[2] The method for attracting cockroaches according to [1], wherein the one or more insect growth-regulating compounds include at least one selected from the group consisting of juvenile hormones, juvenile hormone analogs, and chitin synthesis inhibiting compounds.

[3] The method for attracting cockroaches according to [1] or [2], wherein the one or more insect growth-regulating compounds include at least one of pyriproxyfen, bistrifluron, methoprene, and hydroprene.

[4] A cockroach attractant containing one or more insect growth-regulating compounds as active ingredients for attracting cockroaches.

[5] A method for controlling cockroaches, containing attracting cockroaches using one or more insect growth-regulating compounds.

### Advantageous Effect of the Invention

According to the present invention, it is possible to attract cockroaches using one or more insect growth-regulating compounds.

### BRIEF DESCRIPTION OF THE DRAWINGS

FIG. 1 It is a perspective view schematically illustrating an example of an uneven sheet.

FIG. 2 It is a schematic diagram explaining the cross-sectional shape of uneven sheets.

FIG. 3 It is a planar view schematically illustrating test space used in test examples.

### DESCRIPTION OF EMBODIMENTS

### (Method for Attracting Cockroaches)

The cockroach-attracting method of the present invention (hereinafter sometimes referred to as “the attracting method”) is a method for attracting cockroaches using one or more insect growth-regulating compounds (Insect Growth Regulator; hereinafter sometimes referred to as “IGR compounds”).

IGR compounds are compounds that inhibit the normal growth and development of insects by disrupting insect-specific physiological regulatory functions during insect eggs to adult insect, such as embryonic development, molting and/or metamorphosis, sexual maturation, and dormancy. Examples of the IGR compounds include juvenile hormones and/or their analogs, or chitin synthesis-inhibiting compounds. The IGR compounds used in the attracting method may be one or more, and two or more may also be combined.

Juvenile hormones are hormones involved in the physiological regulatory mechanisms within insect bodies, while juvenile hormone analogs are compounds that are not juvenile hormones but exhibit physiological activity similar to juvenile hormones. Examples of the juvenile hormones and/or their analogs include pyriproxyfen, hydroprene, kinoprene, methoprene, and fenoxycarb.

Chitin synthesis-inhibiting compounds are compounds that inhibit the of cockroaches by interfering with the synthesis of chitin. Examples of the chitin synthesis-inhibiting compounds include etoxazole, bistrifluron, chlorfluazuron, diflubenzuron, fluazuron, flucycloxuron, flufenoxuron, hexaflumuron, lufenuron, novaluron, noviflumuron, teflubenzuron, and triflumuron. The chitin synthesis-inhibiting compound is preferably bistrifluron.

The one or more IGR compounds preferably include one or more selected from the group consisting of juvenile hormones, juvenile hormone analogs, and chitin synthesis-inhibiting compounds, and are more preferably one or more selected from the group consisting of juvenile hormones, juvenile hormone analogs, and chitin synthesis-inhibiting compounds, and even more preferably include at least one of pyriproxyfen, bistrifluron, methoprene, and hydroprene, and are even still more preferably pyriproxyfen, bistrifluron, methoprene, or hydroprene, and are most preferably pyriproxyfen. When the one or more IGR compounds include one or more selected from the group consisting of juvenile hormones, juvenile hormone analogs, and chitin synthesis-inhibiting compounds, the content of these compounds is preferably 80% by weight or more, more preferably 90% by weight or more, and may even be 95% by weight or more, or may be 100% by weight, relative to the total weight of all IGR compounds.

Cockroaches refer to species belonging to the order Blattodea in the class Insecta in taxonomy, and examples thereof include the German cockroach (Blattella germanica), the American cockroach (Periplaneta americana), the Smokybrown cockroach (Periplaneta fuliginosa), the Japanese cockroach (Periplaneta japonica), the Brown cockroach (Periplaneta brunnea), the Oriental cockroach (Blatta orientalis), and the Australian cockroach (Periplaneta australasiae). Preferably, the cockroach is the German cockroach. The cockroach may be female or may be male. The cockroach may be an adult or may be a nymph.

The attracting method is not particularly limited as long as it is a method for attracting cockroaches using one or more IGR compounds. For example, cockroaches can be attracted by applying one or more IGR compounds to the location desired to attract. The application of IGR compounds can be done by spraying, misting, coating, printing, or impregnating. In the application of IGR compounds, the IGR compounds can be used as it is, or can be formulated into liquid agents where the IGR compounds are dissolved or dispersed in solvents, or solid agents where the IGR compounds are supported on solid carriers to use. Examples of the formulation types include oil formulations, emulsifiable concentrates, flowable formulations, wettable powders, water dispersible granules, dustable powders, and granules.

Examples of the solvents used for the liquid agents include water; alcohols such as methanol, ethanol, 2-propanol, butanol, hexanol, benzyl alcohol, ethylene glycol, propylene glycol, and phenoxyethanol; ketones such as acetone, methyl ethyl ketone, and cyclohexanone; aromatic hydrocarbons such as toluene, xylene, ethylbenzene, dodecylbenzene, phenylxylylethane, and methylnaphthalene; aliphatic hydrocarbons such as hexane, cyclohexane, kerosene, and light oil; esters such as ethyl acetate, butyl acetate, isopropyl myristate, ethyl oleate, diisopropyl adipate, diisobutyl adipate, and propylene glycol monomethyl ether acetate; nitriles such as acetonitrile, and isobutyronitrile; ethers such as diisopropyl ether, 1,4-dioxane, ethylene glycol dimethyl ether, diethylene glycol dimethyl ether, diethylene glycol monomethyl ether, propylene glycol monomethyl ether, dipropylene glycol monomethyl ether, and 3-methoxy-3-methyl-1-butanol; acid amides such as N, N-dimethylformamide, and N, N-dimethylacetamide; halogenated hydrocarbons such as dichloromethane, trichloroethane, and carbon tetrachloride; sulfoxides such as dimethyl sulfoxide; and vegetable oils such as soybean oil, and cottonseed oil.

Examples of the solid carriers used for the solid agents include silica compounds such as amorphous silica and crystalline silica; zeolites; clay minerals such as montmorillonite, saponite, beidellite, bentonite, and kaolinite; metal oxides such as zinc oxide, magnesium oxide, aluminum oxide, iron oxide, and copper oxide; micas such as mica and vermiculite; hydrotalcite; and polymer beads using polymers such as crystalline cellulose, polystyrene, (meth)acrylic acid esters, and polyvinyl alcohol.

When formulating IGR compounds, they can be mixed with solvents or solid carriers, and additives can be added as needed to prepare formulations. Examples of the additives include insecticides, repellents, antioxidants, antifungal agents, antibacterial agents, colorants such as pigments, fragrances, deodorants, spreaders, UV absorbers, light stabilizers, lubricants, anti-blocking agents, antistatic agents, surfactants, fillers, flame retardants, plasticizers, and rust inhibitors.

When IGR compounds are formulated, the content of the IGR compounds in the formulation may be 0.1% or more and 20% or less by mass, may be 1% or more and 15% or less by mass, or may be 2% or more and 10% or less by mass, relative to the total mass of the formulation.

The attracting method may be a method for attracting cockroaches by placing a sheet or a trap treated with IGR compounds in the location desired to attract the cockroaches. In this case, the IGR compounds themselves or formulations containing the IGR compounds can be sprayed, misted, coated, printed, impregnated, or placed on the sheet or the trap, or raw materials for forming the sheet or the trap can be mixed with the IGR compounds themselves or formulations containing the IGR compounds to form the sheet or the trap.

When applying IGR compounds to the sheet or the trap by spraying, misting, coating, printing, impregnating, etc., the application amount per unit area is preferably 10 mg or more and 5000 mg or less, more preferably 500 mg or more and 1000 or less mg, per 1 m². Specific examples of the application amount of IGR compounds per unit area include 50 mg, 100 mg, 200 mg, 300 mg, 400 mg, 600 mg, 700 mg, 800 mg, 900 mg, 1500 mg, 2000 mg, 3000 mg, and 4000 mg per 1 m². The application amount can also be expressed using “approximately.” “Approximately” means plus or minus 10%, and for example, “approximately 1000 mg” means 900 to 1100 mg (900 mg or more and 1100 mg or less).

The sheet to which IGR compounds are applied may be a flat sheet without any shape processing or a shape-processed three-dimensional sheet with an uneven shape. The sheet to which IGR compounds are applied may, for example, be an uneven sheet in which concave portions and convex portions are repeatedly and alternatingly formed.

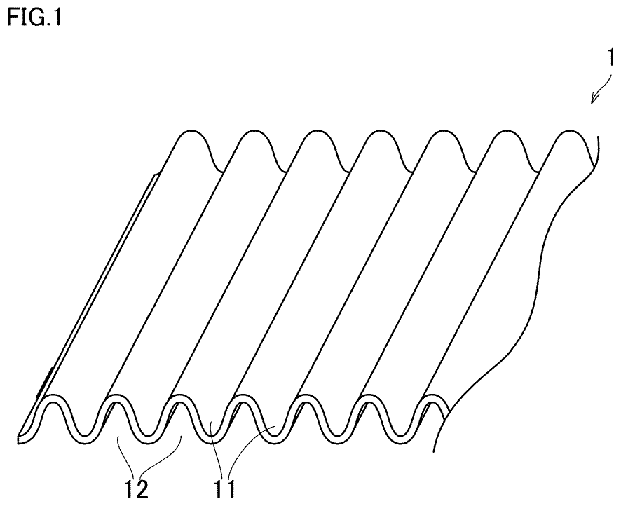

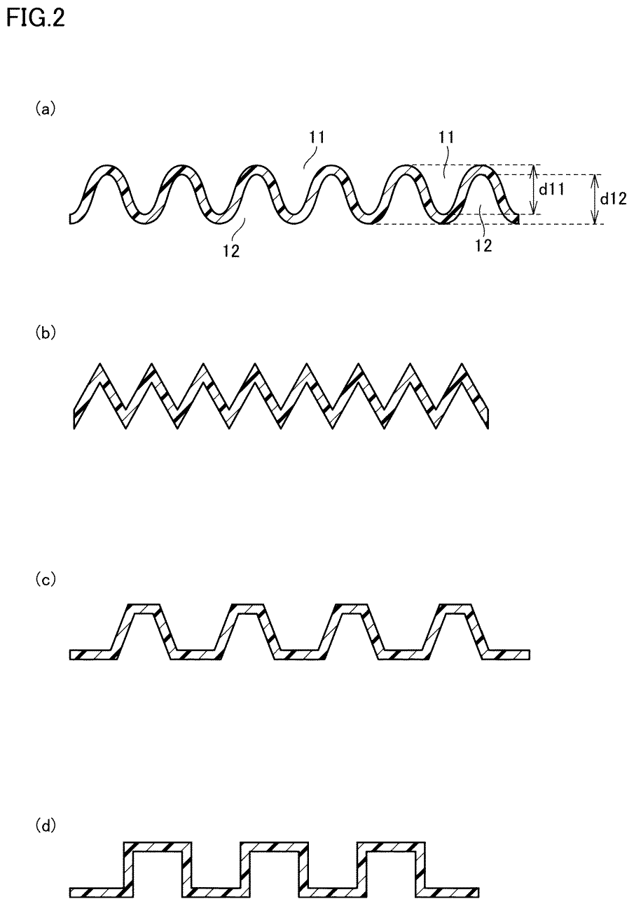

FIG. 1 is a perspective view schematically illustrating an example of an uneven sheet. FIG. 2 is a schematic diagram explaining the cross-sectional shapes of uneven sheets. The uneven sheet 1 may be, for example, a corrugated sheet in which concave portions 11 and convex portions 12 are formed to be corrugated (pleated) as shown in FIG. 1. Each corrugation of the corrugated sheet (the direction in which the tops of the convex portions 12 and the bottoms of the concave portions 11 extend) may extend parallel to at least one side in a planar view of the corrugated sheet (FIG. 1), or may extend in a direction intersecting all sides in a planar view of the corrugated sheet. The concave portions 11 and convex portions 12 may be arranged at regular intervals or may be arranged at irregular intervals.

The cross-sectional shape of the concave portions 11 and convex portions 12 in the corrugated sheet may be a sinusoidal wave shape ((a)), a triangular wave shape ((b)), a trapezoidal wave shape ((c)), a rectangular wave shape ((d)), or a combination thereof, as shown in FIG. 2. For example, if the cross-sectional shape is a shape having corners such as a triangular wave shape, a trapezoidal wave shape, or a rectangular wave shape, at least some or all of the corners may have chamfered R shapes.

In FIG. 1, the case where the uneven sheet 1 is a corrugated sheet is explained, but the shape of the uneven sheet is not limited thereto. For example, it may be an uneven sheet in which concave portions and convex portions are formed so that they may be a lattice shape or a staggered shape. In this case, the cross-sectional shape of the concave portions and convex portions may also be a sinusoidal wave shape, a triangular wave shape, a trapezoidal wave shape, a rectangular wave shape, or a combination thereof, and at least some or all of the corners which these shapes may have R shapes.

The size of the concavity and convexity formed by the uneven sheet 1 should be large enough for cockroaches to enter. For example, in the cross-section of the uneven sheet 1, the depth d11 of the space formed by the concave portion 11 and the height d12 of the space formed by the convex portion 12 may each independently be, for example, 5 mm or more and 30 mm or less, or be 10 mm or more and 20 mm or less. The depth d11 of the concave portion 11 refers to the distance between the position of the surface of the uneven sheet 1 at the deepest point of the concave portion 11 and the position of the surface of the uneven sheet 1 at the highest point of the convex portion 12 (the distance in the direction perpendicular to the surface of the uneven sheet 1), as shown in FIG. 2(a). The height d12 of the convex portion 12 refers to the distance between the position of the underside surface of the uneven sheet 1 at the highest point of the convex portion 12 and the position of the underside surface of the uneven sheet 1 at the lowest point of the concave portion 11 (the distance in the direction perpendicular to the surface of the uneven sheet 1), as shown in FIG. 2(a).

In the cross-section of the uneven sheet 1, if the concave portions 11 and/or the convex portions 12 have vertices, the angles of the vertices of the concave portions 11 and the vertices of the convex portions 12 may each independently be 10° or more and 90° or less, be 40° or more and 60° or less, be 45° or more and 55° or less, or be 50° or more and 55° or less.

The uneven sheet 1 may be composed of netting, woven fabric, knitted fabric, non-woven fabric, and the like. Examples of materials constituting the uneven sheet 1 include natural polymers such as cellulose; synthetic resins such as polyethylene, polypropylene, and polyethylene terephthalate.

The trap is not particularly limited as long as cockroaches can enter to in to capture them. The trap may be, for example, a container with an entrance for cockroaches to enter. The shape of the container is not particularly limited. To capture cockroaches attracted to the trap, the trap may have capturing means such as adhesive members to prevent them from exiting. In the trap, cockroach baits, water and the like can be placed.

The attracting method can be used for controlling cockroaches as explained in the method for controlling cockroaches mentioned later. The attracting method may control cockroaches by using an insecticide that can kill cockroaches along with IGR compounds. If the attracting method is the method for attracting cockroaches using a trap treated with IGR compounds, the attracted cockroaches can be controlled by capturing them in the traps. Alternatively, the cockroaches attracted by the attracting method may be controlled by contacting them with IGR compounds to inhibit their normal growth and development, or cockroaches that have contacted IGR compounds may be allowed to transport the compounds to their colony, where other cockroaches contact the IGR compounds to inhibit their normal growth and development, thereby controlling them.

### (Cockroach Attractant)

The cockroach attractant of the present invention (hereinafter sometimes referred to as “the cockroach attractant”) contains one or more IGR compounds as active ingredients for attracting cockroaches. The cockroach attractant may contain two or more IGR compounds. Examples of the IGR compounds include those mentioned above. The IGR compounds that may be included in the cockroach attractant are preferably one or more selected from the group consisting of juvenile hormones, juvenile hormone analogs, and chitin synthesis inhibiting compounds, more preferably at least one of pyriproxyfen, bistrifluron, methoprene, and hydroprene, even more preferably pyriproxyfen, bistrifluron, methoprene, or hydroprene, and even still more preferably pyriproxyfen.

The content of IGR compounds in the cockroach attractant may be 0.1% or more and 20% or less by mass, may be 1% or more and 15% or less by mass, or may be 2% or more and 10% or less by mass, relative to the total mass of the cockroach attractant.

The cockroach attractant may be the IGR compound itself, or it may be that formulated into a liquid agent or solid formulation using the IGR compound. Examples of the type of the formulations, examples of the materials forming the formulations, and examples of the additives that may be included in the formulations include those described above.

The cockroach attractant may also contain attractant substances that can attract cockroaches besides IGR compounds. Examples of the attractant substances include publicly known dietary substances and attractant compounds. The cockroach attractant may be a mixture of the attractant substances and IGR compounds.

Examples of the attractant substances include sugars such as sucrose, glucose, granulated sugar, fructose, lactose, maltose, brown sugar, red sugar, soft brown sugar, dextrin, arabinose, galactose, sorbitol, molasses, and honey; dairy products such as skim milk, skim milk powder, and cheese; starches derived from corn, potatoes, sweet potatoes and the like; grain flours such as wheat flour, rice flour, corn flour, and potato flour; animal powders and insect powders from cattle, pigs, seafood, and insects; vegetable oils such as coconut oil, cacao oil, corn oil, sesame oil, peanut oil, and salad oil; animal oils such as body fats which are mammal oils, butter fat, oils obtained from birds, reptiles, amphibians, and insects; seasonings such as sauces, and soy sauce; pheromones such as aggregation pheromones.

### (Method for Controlling Cockroaches)

The cockroach-controlling method of the present invention (hereinafter sometimes referred to as “the controlling method”) includes attracting cockroaches using one or more IGR compounds. Examples of the IGR compounds used in the controlling method include those mentioned above. In the controlling method, cockroaches may be attracted by the IGR compounds contained in the cockroach attractant mentioned above. The IGR compounds used in the controlling method are preferably one or more selected from the group consisting of juvenile hormones, juvenile hormone analogs, and chitin synthesis inhibiting compounds, more preferably at least one of pyriproxyfen, bistrifluron, methoprene, and hydroprene, even more preferably pyriproxyfen, bistrifluron, methoprene, or hydroprene, and even still more preferably pyriproxyfen.

In the controlling method, the IGR compound itself may be used, the formulated IGR compound mentioned above may be used, or the cockroach attractant mentioned above may be used.

In the controlling method, the method of controlling attracted cockroaches is not particularly limited. For example, cockroaches may be controlled by contacting the attracted cockroaches with an insecticide to kill them, or cockroaches may be controlled by capturing the attracted cockroaches using capture means such as adhesive members. Alternatively, cockroaches may be controlled by allowing the attracted cockroaches to contact one or more IGR compounds to inhibit their normal growth and development, or cockroaches that have contacted IGR compounds may be allowed to transport the compounds to their colony, where other cockroaches contact the IGR compounds to inhibit their normal growth and development, thereby controlling them.

As the insecticides used to kill cockroaches, known insecticides can be used, and examples thereof include the following carbamate compounds, organophosphorus compounds, phenylpyrazole compounds, pyrethroid compounds, neonicotinoid compounds, spinosyn compounds, avermectin compounds, nereistoxin compounds, oxadiazine compounds, diamide compounds, metadiamide compounds, and isoxazoline compounds.

Examples of the carbamate compounds include alanycarb, benfuracarb, carbaryl (NAC), carbosulfan, fenobucarb (BPMC), methomyl, oxamyl, and thiodicarb.

Examples of the organophosphorus compounds include acephate, cadusafos, chlorpyrifos, cyanophos (CYAP), diazinon, dimethoate, fenitrothion (MEP), fosthiazate, imicyafos, isoxathion, malathion, methidathion (DMTP), phenthoate (PAP), profenofos, and prothiofos.

Examples of the phenylpyrazole compounds include ethiprole, and fipronil.

Examples of the pyrethroid compounds include acrinathrin, bifenthrin, cycloprothrin, cyfluthrin, cyhalothrin, cypermethrin, etofenprox, fenpropathrin, fenvalerate, flucythrinate, fluvalinate, (tau-) fluvalinate, permethrin, silafluofen, tefluthrin, tralomethrin, pyrethrin, cyphenothrin, imiprothrin, transfluthrin, profluthrin, dimefluthrin, metofluthrin, momfluorothrin, allethrin, phthalthrin, resmethrin, flumethrin, phenothrin, empenthrin, and prallethrin.

Examples of the neonicotinoid compounds include acetamiprid, clothianidin, dinotefuran, imidacloprid, nitenpyram, thiacloprid, and thiamethoxam.

Examples of the spinosyn compounds include spinetoram, and spinosad.

Examples of the avermectin compounds include abamectin.

Examples of the nereistoxin compounds include bensultap, cartap, and thiocyclam.

Examples of the oxadiazine compounds include indoxacarb.

Examples of the diamide compounds include chlorantraniliprole, cyantraniliprole, cyclaniliprole, flubendiamide, and tetraniliprole.

Examples of the metadiamide compounds include broflanilide.

Examples of the isoxazoline compounds include fluxametamide.

Examples of other compounds besides those mentioned above include methoxadiazone, and pyridalyl.

As the adhesive members, those that are adhesive at room temperature and non-fluid are preferred. Examples of the adhesive members include adhesive layers coated with adhesives and adhesive sheets with adhesive layers. Materials constituting the adhesive members include known adhesives such as natural rubber, synthetic rubber, polybutene, polyisobutylene, polybutadiene, and ethylene-vinyl acetate copolymers.

### EXAMPLES

The present invention will be explained in more detail with reference to examples and comparative examples, but the present invention is not limited to these examples.

### [Preparation of Uneven Sheet]

A polyethylene terephthalate resin sheet the cross-sectional shape of which is sinusoidal wave shape as shown in FIG. 2(a) was used. Specifically, an uneven sheet (a corrugated sheet) the depth of the concave portion and the height of the convex portion of which were each 10 mm, and where the concave portions and the convex portions were formed in a corrugated shape so that the angle at the vertices of the concave portion might be 53° was prepared. The uneven sheet was used in Test Example 1 and Test Example 2.

### [Test Equipment]

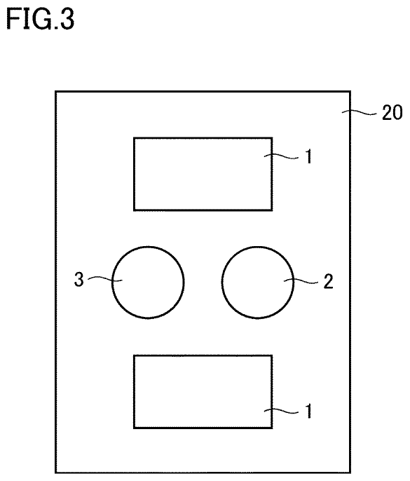

FIG. 3 is a planar view schematically illustrating the test space used in Test Examples 1 to 5. As shown in FIG. 3, an uneven sheet 1 coated with a chemical and an uneven sheet 1 which is blank were arranged to face each other. Depending on the test system, a container 2 containing solid feed for MF mouse rats as bait and a container 3 containing water were placed between these two uneven sheets 1.

### Test Example 1

As shown in FIG. 3, on one side of the lengthwise direction of test space 20 (35 cm long×24 cm wide), an uneven sheet (chemical applied) 1 to which a liquid chemical consisting of 2.7% by mass of pyriproxyfen and 97.3% by mass of 2-propanol had been applied to have 1 g of pyriproxyfen per 1 m², followed by drying was placed, and in a manner facing to this, an uneven sheet (blank) 1 to which the same amount of 2-propanol had been applied, followed by drying was placed. As the uneven sheets 1 placed in the test space 20, all those being 10 cm×10 cm in size were used, and they were placed so that the ridge lines of the corrugations of the uneven sheets 1 were parallel to the lengthwise direction of the test space 20.

As test insects, Periplaneta americana nymphs, Cimex lectularius, Dermanyssus gallinae, Sitophilus zeamais, and Plodia interpunctella larvae were used. Cimex lectularius and Dermanyssus gallinae were released into each test space 20 where feed and water had not been placed and only corrugated sheets 1 had been placed. Periplaneta americana nymphs were released into test space 20 where containers 2 and 3 containing feed and water respectively placed between the facing uneven sheets 1 as shown in FIG. 3. Sitophilus zeamais and Plodia interpunctella larvae were released into each test space 20 where feed and water had not been placed and brown rice had been placed on uneven sheets 1 as a hiding place for the test insects.

Four days after releasing the insects, the number of individuals settled in each uneven sheet 1 and the number of individuals present in the test space 20 other than the uneven sheets 1 were counted. The above test was conducted in two repetitions. The total results of the two repetitions are shown in Table 1.

TABLE 1

| | | Number of individuals | | | Hiding |
|---|---|---|---|---|---|
| | | Uneven | | Other | rate |
| | Number of | sheet | Uneven | than | (Chemical |
| | released | (chemical | sheet | uneven | applied / |
| Test insect | insects | applied) | (Blank) | sheets | Blank) |
| Periplaneta | 60 | 39 | 21 | 0 | 1.86 |
| americana | | | | | |
| nymphs | | | | | |
| Cimex | 30 | 12 | 16 | 2 | 0.75 |
| lectularius | | | | | |
| Dermanyssus | 59 | 17 | 18 | 24 | 0.94 |
| gallinae | | | | | |
| Sitophilus | 60 | 21 | 33 | 6 | 0.64 |
| zeamais | | | | | |
| Plodia | 60 | 23 | 37 | 0 | 0.62 |
| interpunctella | | | | | |
| larvae | | | | | |

As shown in Table 1, it was confirmed that the attracting effect of pyriproxyfen is specific to cockroaches. Other insect regulating compounds are also expected to have similar effects.

### Test Example 2

As shown in FIG. 3, on one side of the lengthwise direction of test space 20 (41.4 cm long×31.4 cm wide), an uneven sheet (chemical applied) 1 to which 5 mL of acetone solution of pyriproxyfen had been dropped to have a predetermined amount of pyriproxyfen per 1 m² shown in Table 2, followed by drying was placed, and in a manner facing to this, an uneven sheet (blank) 1 to which the same amount of acetone had been dropped, followed by drying was placed. As the uneven sheets 1 placed in the test space 20, all those being 10 cm×16 cm in size were used, and they were placed so that the ridge lines of the corrugations of the uneven sheets 1 were parallel to the lengthwise direction of the test space 20. Additionally, containers 2 and 3 containing feed and water respectively were placed between the facing uneven sheets 1.

In the test space 20 prepared as described above, Blattella germanica (30 individuals in total) were released, and four hours later, the number of individuals settled in each uneven sheet 1 and the number of individuals present in the test space 20 other than the uneven sheets 1 were counted. The above test was conducted in four repetitions. The total results of the four repetitions are shown in Table 2.

TABLE 2

| | | Number of individuals | | | Hiding |
|---|---|---|---|---|---|
| | | Uneven | | Other | rate |
| Amount of | Number of | sheet | Uneven | than | (Chemical |
| pyriproxyfen | released | (chemical | sheet | uneven | applied / |
| [mg/m²] | insects | applied) | (Blank) | sheets | Blank) |
| 10 | 120 | 78 | 40 | 2 | 1.95 |
| 100 | 120 | 70 | 46 | 4 | 1.52 |
| 500 | 120 | 98 | 18 | 4 | 5.44 |
| 1000 | 120 | 91 | 28 | 1 | 3.25 |
| 2000 | 120 | 67 | 48 | 5 | 1.40 |
| 5000 | 120 | 71 | 46 | 3 | 1.54 |

### Test Example 3

### [Preparation of Uneven Sheet]

A sheet formed from a filter paper (ADVANTEC qualitative filter paper No. 2, manufactured by Toyo Roshi Kaisha, Ltd.) wherein the sheet was a triangular wave shape in its cross-sectional shape as shown in FIG. 2(b) was used. Specifically, an uneven sheet (a corrugated sheet) the depth of the concave portion and the height of the convex portion of which were each 17 mm, and where the concave portions and the convex portions were formed in a corrugated shape so that the angle at the vertices of the concave portions might be 60° was prepared.

As shown in FIG. 3, on one side of the lengthwise direction of test space 20 (41.4 cm long×31.4 cm wide), an uneven sheet (chemical applied) 1 to which 5 mL of acetone solution of bistrifluron had been dropped to have 1 g of bistrifluron per 1 m², followed by drying was placed, and in a manner facing to this, an uneven sheet (blank) 1 to which the same amount of acetone had been dropped, followed by drying was placed. As the uneven sheets 1 placed in the test space 20, all those being 10 cm×16 cm in size were used, and they were placed so that the ridge lines of the corrugations of the uneven sheets 1 were parallel to the lengthwise direction of the test space 20. Additionally, containers 2 and 3 containing feed and water respectively were placed between the facing uneven sheets 1.

In the test space 20 prepared as described above, Blattella germanica (30 individuals in total) were released, and four hours later, the number of individuals settled in each uneven sheet 1 and the number of individuals present in the test space 20 other than the uneven sheets 1 were counted. The above test was conducted in four repetitions. The total results of the four repetitions are shown in Table 3.

TABLE 3

| | | Number of individuals | | | Hiding |
|---|---|---|---|---|---|
| | | Uneven | | Other | rate |
| | Number of | sheet | Uneven | than | (Chemical |
| | released | (chemical | sheet | uneven | applied / |
| Test insect | insects | applied) | (Blank) | sheets | Blank) |
| Blattella | 120 | 71 | 31 | 18 | 2.29 |
| germanica | | | | | |

### Test Example 4

### [Preparation of Uneven Sheet]

A sheet formed from a filter paper (ADVANTEC qualitative filter paper No. 2, manufactured by Toyo Roshi Kaisha, Ltd.) wherein the sheet was a triangular wave shape in its cross-sectional shape as shown in FIG. 2(b) was used. Specifically, an uneven sheet (a corrugated sheet) the depth of the concave portion and the height of the convex portion of which were each 17 mm, and where the concave portions and the convex portions were formed in a corrugated shape so that the angle at the vertices of the concave portions might be 60° was prepared.

As shown in FIG. 3, on one side of the lengthwise direction of test space 20 (41.4 cm long×31.4 cm wide), an uneven sheet (chemical applied) 1 to which 5 mL of acetone solution of methoprene had been dropped to have 1 g of methoprene per 1 m², followed by drying was placed, and in a manner facing to this, an uneven sheet (blank) 1 to which the same amount of acetone had been dropped, followed by drying was placed. As the uneven sheets 1 placed in the test space 20, all those being 10 cm×16 cm in size were used, and they were placed so that the ridge lines of the corrugations of the uneven sheets 1 were parallel to the lengthwise direction of the test space 20. Additionally, containers 2 and 3 containing feed and water respectively were placed between the facing uneven sheets 1.

In the test space 20 prepared as described above, Blattella germanica (30 individuals in total) were released, and four hours later, the number of individuals settled in each uneven sheet 1 and the number of individuals present in the test space 20 other than the uneven sheets 1 were counted. The above test was conducted in eight repetitions. The total results of the eight repetitions are shown in Table 4.

TABLE 4

| | | Number of individuals | | | Hiding |
|---|---|---|---|---|---|
| | | Uneven | | Other | rate |
| | Number of | sheet | Uneven | than | (Chemical |
| | released | (chemical | sheet | uneven | applied / |
| Test insect | insects | applied) | (Blank) | sheets | Blank) |
| Blattella | 240 | 152 | 52 | 36 | 2.92 |
| germanica | | | | | |

### Test Example 5

### [Preparation of Uneven Sheet]

A sheet formed from a filter paper (ADVANTEC qualitative filter paper No. 2, manufactured by Toyo Roshi Kaisha, Ltd.) wherein the sheet was a triangular wave shape in its cross-sectional shape as shown in FIG. 2(b) was used. Specifically, an uneven sheet (a corrugated sheet) the depth of the concave portion and the height of the convex portion of which were each 17 mm, and where the concave portions and the convex portions were formed in a corrugated shape so that the angle at the vertices of the concave portions might be 60° was prepared.

As shown in FIG. 3, on one side of the lengthwise direction of test space 20 (41.4 cm long×31.4 cm wide), an uneven sheet (chemical applied) 1 to which 5 mL of acetone solution of hydroprene had been dropped to have 500 mg of hydroprene per 1 m², followed by drying was placed, and in a manner facing to this, an uneven sheet (blank) 1 to which the same amount of acetone had been dropped, followed by drying was placed. As the uneven sheets 1 placed in the test space 20, all those being 10 cm×16 cm in size were used, and they were placed so that the ridge lines of the corrugations of the uneven sheets 1 were parallel to the lengthwise direction of the test space 20. Additionally, containers 2 and 3 containing feed and water respectively were placed between the facing uneven sheets 1.

In the test space 20 prepared as described above, Blattella germanica (30 individuals in total) were released, and 24 hours later, the number of individuals settled in each uneven sheet 1 and the number of individuals present in the test space 20 other than the uneven sheets 1 were counted. The above test was conducted in eight repetitions. The total results of the eight repetitions are shown in Table 5.

TABLE 5

| | | Number of individuals | | | Hiding |
|---|---|---|---|---|---|
| | | Uneven | | Other | rate |
| | Number of | sheet | Uneven | than | (Chemical |
| | released | (chemical | sheet | uneven | applied / |
| Test insect | insects | applied) | (Blank) | sheets | Blank) |
| Blattella | 240 | 160 | 75 | 5 | 2.13 |
| germanica | | | | | |

### REFERENCE SIGNS LIST

1 Uneven sheet, 2 Container containing feed, 3 Container containing water, 11 Concave portion, 12 Convex portion, 20 Test space.

1. A method for attracting cockroaches, attracting cockroaches using one or more insect growth-regulating compounds.

2. The method for attracting cockroaches according to claim 1, wherein the one or more insect growth-regulating compounds comprise at least one selected from the group consisting of juvenile hormones, juvenile hormone analogs, and chitin synthesis inhibiting compounds.

3. The method for attracting cockroaches according to claim 1- or 2, wherein the one or more insect growth-regulating compounds comprise at least one of pyriproxyfen, bistrifluron, methoprene, and hydroprene.

4. A cockroach attractant comprising one or more insect growth-regulating compounds as active ingredients for attracting cockroaches.

5. A method for controlling cockroaches, comprising attracting cockroaches using one or more insect growth-regulating compounds.
